(19) United States
(12) Patent Application Publication
(10) Pub. No.: US 2021/0188731 A1
(43) Pub. Date: Jun. 24, 2021

(54) One-Off Fertilization Method Suitable for Winter Wheat in Areas with Less Rainfall in Spring

(71) Applicant: Institute of Agricultural Resources and Environment, Shandong Academy of Agricultural Sciences, Jinan (CN)

(72) Inventors: Deshui Tan, Jinan (CN); Zhaohui Liu, Jinan (CN); Haitao Lin, Jinan (CN); Yan Li, Jinan (CN); Lihua Jiang, Jinan (CN); Yingpeng Zhang, Jinan (CN); Yufeng Zhang, Jinan (CN); Xiaobin Wu, Jinan (CN)

(73) Assignee: Institute of Agricultural Resources and Environment, Shandong Academy of Agricultural Sciences, Jinan (CN)

(21) Appl. No.: 16/724,360

(22) Filed: Dec. 22, 2019

(51) Int. Cl. C05G 5/30; C05C 9/00; C05B 7/00; C05B 1/02; C05B 1/04; C05B 19/02; C05D 1/02; C05D 1/00; C05G 5/12; A01C 21/00; A01C 5/06; A01C 7/08; A01C 7/06

(52) U.S. Cl. CPC C05G 5/37; C05C 9/005; C05B 7/00; C05B 1/02; C05B 1/04; C05B 19/02; A01C 7/06; C05D 1/005; C05G 5/12; A01C 21/00; A01C 5/062; A01C 7/08; C05D 1/02

(57) ABSTRACT

A one-off fertilization method suitable for winter wheat in areas with less rainfall in spring includes the following steps: (1) carrying out, on a flat wheat block which is suitable for mechanized operations and after the harvest of preceding crops, a deep ploughing or a subsoiling in combination with a rotary tillage and a one-off fertilization for land preparation, without involving any top dressing in a later stage; and (2) carrying out a seeding operation by a wheat seeder, wherein for nitrogen fertilizer, according to the nitrogen release period of a controlled-release nitrogen fertilizer, one of the following application modes is determined: applying a polyurethane-coated controlled-release nitrogen fertilizer alone or a water-based resin-coated controlled-release nitrogen fertilizer special for winter wheat alone; or applying a water-based resin-coated controlled-release nitrogen fertilizer special for winter wheat in combination with 20% to 30% of a polyurethane-coated controlled-release nitrogen fertilizer.

### TECHNICAL FIELD

The present invention relates to a one-off fertilization method suitable for winter wheat in areas with less rainfall in spring, wherein the fertilization method requires no top dressing and falls within the technical field of agricultural fertilization.

### BACKGROUND

Wheat is the largest food crop in the world and is widely distributed due to its strong adaptation, and is planted from near arctic regions to the equator and from the basin to the plateau. Wheat needs a dry, mild climate to grow, and thus is mainly planted in areas between 67° north latitude and 45° south latitude, especially in the Eurasian continent and North America in northern hemisphere. In these areas, the cultivated area accounts for about 90% of world's total cultivated area. In areas where annual precipitation is less than 230 mm and in near-arctic regions which are hot and too humid, wheat is fewer planted. Globally, wheat is the most widely-planted crop, has the largest cultivated area and total volume of trade, and has a much greater impact on global food security than any other crop. Wheat productivity is directly related to the increase of agricultural efficiency and farmers' income in developing countries.

The cultivated area of winter wheat accounts for about 75% of the world's total cultivated area of wheat. The development stage for winter wheat generally requires about 240 days, covering fall-winter, spring and early summer. Since the rule of nutrient absorption varies greatly with the progress of development and with seasonal changes, and different development stages require different nutrient inputs, nutrient management is particularly important. According to the category management for fertilization, winter wheat undergoes the following three stages: before wintering stage, returning green-jointing stage, and booting-maturity stage. Among these three stages, the returning green jointing stage is a critical period for fertilization in winter wheat production and plays an important role in yield formation. Top dressing nitrogen fertilizers is required at this stage (mainly comprising the application of nitrogen nutrients, which is determined by the characteristic that nitrogen may easily lost in a gaseous form or in an aqueous solution; whereas after application, phosphorus and potassium nutrients may easily be fixed and not easily lost). Fertilizer nutrients can act on wheat root system only with the rainfall or irrigation. However, at the returning green jointing stage, most of the cultivated areas of winter wheat are in spring during which rainfall is rare. Therefore, manual irrigation is required along with fertilization, and both manual irrigation and fertilization are necessary labor work. In summary, during the conventional cultivation of winter wheat, 2 to 3 times of fertilization are generally carried out in the whole development stage, resulting in frequent top dressing and cumbersome production process. As the rapid advancement of rural urbanization which causes continuous outward transfer of labor forces and the fact that the crop production brings about relatively low benefits, it has become a common phenomenon that no top dressing or unsuitable top dressing is carried out in food production. It is an irreconcilable contradiction that the requirement of top dressing in spring for ensuring the nutrient supply in the later stages in winter wheat production is difficult to be satisfied because of the shortage of agricultural labor, which seriously affects the safety and stability of food production. Under such circumstances, there is a pressing need to develop a simplified fertilization mode for winter wheat.

At present, there are patents relating to the simplified fertilization method for wheat. For example, Chinese patent document CN 102918980 A discloses a fertilization method for applying special controlled-release urea fertilizers for winter wheat and summer corn crop-rotation field in “one basal N application and one topdressing N application” pattern, wherein the nitrogen fertilizer comprises 60%-100% of controlled-release urea special for field in combination with common urea; however, the fertilizers and fertilization processes disclosed in this patent are not commercialized and difficult to realize large-scale promotion and application. Chinese patent document CN 102017839 A discloses a simplified fertilization method for annual wheat-corn rotation system, which method relates to an annual fertilization mode of carrying out fertilizer application twice in the wheat season and once in the corn season, which is different from the conventional fertilization mode of carrying out fertilizer application twice or three times in the wheat season and at least twice in the corn season. Even though the fertilization process has been simplified, the one-off fertilization of wheat still fails to be achieved, nor disclosed in the prior art.

### SUMMARY

In view of the deficiencies of the prior art, the present invention provides a one-off fertilization method suitable for winter wheat in areas with less rainfall in spring.

### The Technical Solutions of the Present Invention are as Follows

A one-off fertilization method suitable for winter wheat in areas with less rainfall in spring, the method comprising the following steps:

(1) on a flat field which is suitable for mechanized operations and after the harvest of preceding crops, carrying out a deep ploughing or a subsoiling in combination with a rotary tillage and a one-off fertilization for land preparation, without involving any top dressing in a later stage; and

(2) carrying out a seeding operation by a wheat seeder.

The fertilizer nutrients applied to the soil in the one-off fertilization is mainly defined by macronutrient fertilizers.

For nitrogen fertilizer, according to the nitrogen release period of a controlled-release nitrogen fertilizer, one of the following application modes is determined, wherein the percentages are based on a total input of pure nitrogen, in mass ratio:

a. applying a polyurethane-coated controlled-release nitrogen fertilizer alone;

b. applying a water-based resin-coated controlled-release nitrogen fertilizer special for wheat alone;

c. applying a water-based resin-coated controlled-release nitrogen fertilizer special for wheat in combination with 20% to 30% of a polyurethane-coated controlled-release nitrogen fertilizer; or

d. applying a thermosetting/thermosetting resin-coated controlled-release nitrogen fertilizer in combination with 10% to 40% of a quick-acting nitrogen fertilizer;

for phosphate fertilizer, it can be selected from a monoammonium phosphate fertilizer, a diammonium phosphate fertilizer, a superphosphate fertilizer or a triple superphosphate fertilizer; and

for potassium fertilizer, it is selected from a potassium chloride fertilizer or a potassium sulfate fertilizer; wherein

the above-mentioned fertilizers are all in the form of granules for the convenience of mechanical application.

The applied amount of the fertilizers are as follows:

for a wheat field with a high soil fertility which has ≥20 cm of the plough layer depth, ≥2.0% of soil organic matter content for 0-20 cm of soil layer, ≥0.125% of the total nitrogen content, ≥120 mg/kg of the alkali-hydrolyzable nitrogen content, ≥30 mg/kg of the quick-acting phosphorus content, ≥150 mg/kg of the quick-acting potassium content and a pH of 6.0-8.0: applying 240-300 kg·ha⁻¹ of the nitrogen fertilizer (in pure N), 135-180 kg·ha⁻¹ of the phosphate fertilizer (in P₂O₅), and 105-150 kg·ha⁻¹ of the potassium fertilizer (in K₂O);

for a wheat field with a medium soil fertility which has 15-20 cm of the plough layer depth, 1.5%-2.0% of soil organic matter content for 0-20 cm of soil layer, 0.10%-0.125% of the total nitrogen content, 90-120 mg/kg of the alkali-hydrolyzable nitrogen content, 20-30 mg/kg of the quick-acting phosphorus content, 100-150 mg/kg of the quick-acting potassium content and a pH of 8.0-8.5 or 5.5-6.0: applying 180-240 kg·ha⁻¹ of the nitrogen fertilizer (in pure N), 105-135 kg·ha⁻¹ of the phosphate fertilizer (in P₂O₅), and 75-105 kg·ha⁻¹ of the potassium fertilizer (in K₂O); and

for a wheat field with a low soil fertility which has ≤15 cm of the plough layer depth, ≤1.5% of soil organic matter content for 0-20 cm of soil layer, ≤0.10% of the total nitrogen content, ≤90 mg/kg of the alkali-hydrolyzable nitrogen content, ≤20 mg/kg of the quick-acting phosphorus content, ≤100 mg/kg of the quick-acting potassium content and a pH of 8.5-9.0 or 5.0-5.5: applying 120-180 kg·ha⁻¹ of the nitrogen fertilizer (in pure N), 75-105 kg·ha⁻¹ of the phosphate fertilizer (in P₂O₅), and 45-75 kg·ha⁻¹ of the potassium fertilizer (in K₂O).

According to the Present Invention, Preferably,

The polyurethane-coated controlled-release nitrogen fertilizer in step (2) meets the following requirements: ≤12% of the initial release rate of nitrogen, ≤75% of the cumulative nutrient release rate within 28 days, ≥80% of the cumulative nutrient release rate in the nitrogen release period, and ≥60 days of the release period of nitrogen nutrients.

The water-based resin-coated controlled-release nitrogen fertilizer special for wheat in step (2) meets the following requirements: ≤12% of the initial release rate of nitrogen, ≤75% of the cumulative nutrient release rate within 28 days, and ≥80% of the cumulative nutrient release rate in the nitrogen release period; and if the nitrogen release period is ≥60 days, the fertilizer special for wheat can be applied alone; and if the nitrogen release period is >28 days, the fertilizer special for wheat can be applied in combination with 20% to 30% of the polyurethane-coated controlled-release nitrogen fertilizer.

The thermoplastic or thermosetting resin-coated controlled-release nitrogen fertilizer in step (2) meets the following requirements: ≤12% of the initial release rate of nitrogen, ≤75% of the cumulative nutrient release rate within 28 days, and ≥80% of the cumulative nutrient release rate in the nitrogen release period; and if the nitrogen release period of the fertilizer of a product is >120 days, the product should be applied in combination with 30% to 40% of a quick-acting nitrogen fertilizer; and if the nitrogen release period of the fertilizer of the product is ≤120 days, the product should be applied in combination with 10% to 30% of a quick-acting nitrogen fertilizer.

The quick-acting nitrogen fertilizer is a common urea fertilizer (nitrogen content N≥46%), a monoammonium phosphate fertilizer (nitrogen content N≥12%), or a diammonium phosphate fertilizer (nitrogen content N≥18%).

The fertilizers are all in the form of granules.

The one-off fertilization operation in land preparation is as follows: evenly distributing the required fertilizers, by using a mechanical device, to the soil surface before the mechanical operation of deep ploughing or rotary tillage for land preparation in step (1), and then evenly mixing all the fertilizers with soil by using a subsoiler or a rotary blade, wherein under the deep ploughing, the fertilizers are evenly mixed with soil in 20-25 cm of soil layer, and under the rotary tillage, the fertilizers are evenly mixed with soil in 10-15 cm of soil layer.

The method for the seeding operation is as follows: the wheat seeder in step (2) is hung on a tractor and is operated with the traction of the tractor; furrows are made by a furrow opener which is connected to a seed tank of the seeder; seeds fall into the furrows which have a depth of 2 to 4 cm, and a pressing operation is performed by press wheels immediately after seed falling.

The techniques and equipment used in the present invention, unless specifically described, are all techniques and equipment commonly used in the prior art.

The Present Invention has the Following Beneficial Effects:

1. The fertilizers required for the one-off fertilization method for winter wheat of the present invention have been commercially produced, and is easily purchased on the market and used in combination. The combined operation machine for achieving the one-off fertilization method is also commonly available in the market.

2. The one-off fertilization method of the present invention can avoid the occurrence of “seedlings burnt” while seeding caused by the large amount application of high-nitrogen compound fertilizers commonly used in “yi pao hong” (one fertilization method which applies all the fertilizers at one time without further top dressing), and can also avoid the occurrence of “seeds burnt” caused by the small distance between the fertilizers and the seeds in some cases when conducting the fertilization operation and the seeding operation at the same time. The combination application of different types of controlled-release nitrogen fertilizers and common urea fertilizers takes into account the requirements of the nitrogen nutrient supply during all development stages of wheat, which can not only avoid the wheat to be over-fertilized in the early stage, but also avoid the fertilizer deficiency in the later stage of growth and development.

3. The present invention reduces operation steps in the production, and also avoids the situation that the top dressing cannot be carried out because of farmers going out for non-farming job in spring, which saving 7-15 labors per hectare. Moreover, due to the controlled-release performance of nitrogen fertilizers, by the present invention, the nitrogen fertilizer inputs can be reduced by 15%-20% compared to conventional fertilization regime while ensuring wheat yield. Therefore, both labors and nitrogen fertilizer inputs are saved.

4. The fertilization method of the present invention can ensure the wheat yield stability or slightly-increased, and can obtain 1000-2500 yuan·ha⁻¹ by cost saving and benefit increasing, which improves the farmers' income.

5. Compared to the conventional production operations, the present invention can increase the utilization efficiency of nitrogen fertilizers by 5%-10% and reduce the loss of nitrate nitrogen by at least 20%, reducing the agricultural non-point source pollution.

### DETAILED DESCRIPTION OF THE EMBODIMENTS

The present invention is further described by but not limited to the following embodiments. In these embodiments, the polyurethane-coated controlled-release nitrogen fertilizer is produced by Shandong Maoshi Ecological Fertilizer Co., Ltd.; the water-based resin-coated controlled-release nitrogen fertilizer and the thermoplastic or thermosetting resin-coated controlled-release nitrogen fertilizer are produced by Shandong Kingenta Ecological Engineering Co., Ltd.

All “%” in the embodiments refer to mass percentages.

### Embodiment 1

A one-off fertilization method suitable for winter wheat in areas with less rainfall in spring, the method comprising the following steps:

(1) carrying out, on a flat wheat block which is suitable for mechanized operations and after the harvest of preceding crops, a subsoiling in combination with a rotary tillage for land preparation, wherein the required fertilizers are evenly distributed on the soil surface before the rotary tillage and are evenly mixed with the soil during the rotary tillage which achieves a depth of 15 cm, without involving any top dressing in a later stage; and

(2) carrying out a seeding operation by a wheat seeder, wherein the following fertilizers can be selected: a polyurethane controlled-release nitrogen fertilizer with ≥60 days of the release period of nitrogen nutrients, a triple superphosphate fertilizer as the phosphate fertilizer and a granular potassium chloride fertilizer as the potassium fertilizer;

for a wheat field with a high soil fertility, apply 270 kg·ha⁻¹ (in pure N) of the nitrogen fertilizer, 135 kg·ha⁻¹ (in P₂O₅) of the phosphate fertilizer, and 112.5 kg·ha⁻¹ (in K₂O) of the potassium fertilizer.

The method for the mechanical seeding operation is as follows: the wheat seeder is hung on a tractor and is operated with the traction of the tractor on the field for which the rotary tillage has done, wherein furrows made by a seed furrow opener have a depth of 3.5 cm, and a pressing operation is performed by press wheels immediately after seeding.

### Embodiment 2

A one-off fertilization method suitable for winter wheat in areas with less rainfall in spring, the method comprising the following steps:

(1) carrying out, on a flat wheat block which is suitable for mechanized operations and after the harvest of preceding crops, a subsoiling in combination with a rotary tillage for land preparation, wherein the required fertilizers are evenly distributed on the soil surface before the rotary tillage and are evenly mixed with the soil during the rotary tillage which achieves a depth of 12 cm, without involving any top dressing in a later stage; and

(2) carrying out a seeding operation by a wheat seeder, wherein the following fertilizers can be selected: a water-based resin-coated controlled-release nitrogen fertilizer special for wheat with >28 days of the nitrogen release period, in combination with 30% (mass percent) of the polyurethane-coated controlled-release nitrogen fertilizer with ≥60 days of the release period of nitrogen nutrients, a triple superphosphate fertilizer as the phosphate fertilizer and a granular potassium chloride fertilizer as the potassium fertilizer;

for a wheat field with a low soil fertility, apply 180 kg·ha⁻¹ (in pure N) of the nitrogen fertilizer, 90 kg·ha⁻¹ (in P₂O₅) of the phosphate fertilizer, and 60 kg·ha⁻¹ (in K₂O) of the potassium fertilizer.

The method for the mechanical seeding operation is as follows: the wheat seeder is hung on a tractor and is operated with the traction of the tractor on the field for which the rotary tillage has done, wherein furrows made by a seed furrow opener have a depth of 3 cm, and a pressing operation is performed by press wheels immediately after seeding.

### Embodiment 3

A one-off fertilization method suitable for winter wheat in areas with less rainfall in spring, the method comprising the following steps:

(1) carrying out, on a flat wheat block which is suitable for mechanized operations and after the harvest of preceding crops, a deep ploughing in combination with a rotary tillage for land preparation, wherein the required fertilizers are evenly distributed on the soil surface before the deep ploughing and are evenly mixed with the soil during the deep ploughing which achieves a depth of 25 cm, and then performing the rotary tillage, without involving any top dressing in a later stage; and

(2) carrying out a seeding operation by a wheat seeder, wherein

the following fertilizers can be selected: a water-based resin-coated controlled-release nitrogen fertilizer special for wheat with ≥60 days of the release period of nitrogen, a superphosphate fertilizer as the phosphate fertilizer, and a granular potassium sulfate fertilizer as the potassium fertilizer;

for a wheat field with a medium soil fertility, apply 225 kg·ha⁻¹ (in pure N) of the nitrogen fertilizer, 105 kg·ha⁻¹ (in P₂O₅) of the phosphate fertilizer, and 90 kg·ha⁻¹ (in K₂O) of the potassium fertilizer.

The method for the mechanical seeding operation is as follows: the wheat seeder is hung on a tractor and is operated with the traction of the tractor on the field for which the deep ploughing and the rotary tillage have done, wherein furrows made by a seed furrow opener have a depth of 2 cm, and a pressing operation is performed by press wheels immediately after seeding.

### Embodiment 4

A one-off fertilization method suitable for winter wheat in areas with less rainfall in spring, the method comprising the following steps:

(1) carrying out, on a flat wheat block which is suitable for mechanized operations and after the harvest of preceding crops, a deep ploughing in combination with a rotary tillage for land preparation, wherein the required fertilizers are evenly distributed on the soil surface before the deep ploughing and are evenly mixed with the soil during the deep ploughing which achieves a depth of 20 cm, and then performing the rotary tillage, without involving any top dressing in a later stage; and

(2) carrying out a seeding operation by a wheat seeder, wherein the following fertilizers can be selected: a thermoplastic resin-coated controlled-release nitrogen fertilizer with >120 days of the nitrogen release period of the product, in combination with 35% (in pure nitrogen, that is, nitrogen in the urea nitrogen fertilizer and the diammonium phosphate fertilizer accounts for 35% of total nitrogen applied) of a quick-acting nitrogen fertilizer (composed of a diammonium phosphate fertilizer and a urea fertilizer), a diammonium phosphate fertilizer as the phosphate fertilizer and a granular potassium chloride fertilizer as the potassium fertilizer;

for a wheat field with a high soil fertility, apply 240 kg·ha⁻¹ (in pure N) of the nitrogen fertilizer, 135 kg·ha⁻¹ (in P₂O₅) of the phosphate fertilizer, and 105 kg·ha⁻¹ (in K₂O) of the potassium fertilizer.

The method for the mechanical seeding operation is as follows: the wheat seeder is hung on a tractor and is operated with the traction of the tractor on the field for which the deep ploughing and the rotary tillage have done, wherein furrows made by a seed furrow opener have a depth of 3.5 cm, and a pressing operation is performed by press wheels immediately after seeding.

The beneficial effects of the present invention are described by but not limited to the following experimental examples.

### Experimental Example 1

A comparative experiment was performed between the one-off fertilization method suitable for winter wheat in areas with less rainfall in spring of embodiment 1 and the local traditional fertilization method which applies the same amount of phosphorus and potassium nutrients and a 15%-reduced amount of the nitrogen nutrients compared to that in the one-off fertilization method. The comparative experiment was conducted in two sites, Dezhou and Tai'an of Shandong province from 2014 to 2015. For the traditional fertilization method, the nitrogen, phosphorus and potassium were derived from compound fertilizers and urea fertilizers (the compound fertilizers were used as base fertilizers and were applied before seeding; land preparation was carried out by means of a sub soiling and a rotary tillage; in the jointing stage in spring, urea fertilizers were applied and then irrigation was conducted; and the ratio of basal fertilizer to top dressing of nitrogen fertilizers was 3:7), and after the fertilization and the land preparation, the seeding was carried out, wherein furrows were made by a seed-furrow opener and had a depth of 3.5 cm. Other field management and operations were consistent between the one-off fertilization and the traditional fertilization. Table 1 showed the comparative analysis for nutrient input, labor input, average yield, benefit, and the utilization efficiency of nitrogen fertilizer between the two test sites.

TABLE 1
Comparison between the one-off fertilization method and the traditional
fertilization method for winter wheat

| | | | | | Utilization |
|---|---|---|---|---|---|
| | | | | | efficiency |
| | | Number of | Wheat | Net | of |
| | Nitrogen | labors | grain | income | nitrogen |
| | input | (person · | yield | (yuan · | fertilizer |
| | (kg · ha⁻¹) | ha⁻¹) | (kg · ha⁻¹) | ha⁻¹) | (%) |
| Traditional | 318 | 45 | 8980 | 11305 | 28.5 |
| fertilization | | | | | |
| method | | | | | |
| One-off | 270 | 30 | 9130 | 13425 | 35.6 |
| fertilization | | | | | |
| method | | | | | |

It could be seen from table 1 that compared with the traditional fertilization method, the one-off fertilization method for winter wheat increased the wheat gain yield by 1.7% where the nitrogen input was reduced by 15%, and was capable of maintaining stable yield. Moreover, in terms of labor saving and net income increasing, the one-off fertilization method was obviously superior to the traditional fertilization method with average 15 labors saved per hectare and a 2120 yuan increased in net income per hectare; in addition, the utilization efficiency of nitrogen fertilizers of the one-off fertilization method was 7.1% higher than that of the traditional fertilization method. Therefore, the one-off fertilization method had obvious advantages.

### Experimental Example 2

The one-off fertilization method suitable for winter wheat in areas with less rainfall in spring of embodiment 2 was used, and an experiment was conducted in 8 typical counties or cities in the middle areas, southwest and middle south of Shandong province from 2014 to 2015. For the traditional fertilization method, the input of each pure nutrient was the same as that in embodiment 2; the nitrogen, phosphorus and potassium were derived from compound fertilizers and urea fertilizers (the compound fertilizers were used as base fertilizers and were applied before seeding; land preparation was carried out by means of a subsoiling and a rotary tillage; in the returning green stage in spring, urea fertilizers were applied and then irrigation was conducted; and the ratio of basal fertilizer to top dressing of nitrogen fertilizers was 4:6), and after the fertilization and the land preparation, the seeding was carried out, wherein furrows were made by a seed-furrow opener and had a depth of 3 cm. Other field management and operations were consistent between the one-off fertilization and the traditional fertilization. Table 2 showed the comparative analysis for average yield, cost-effectiveness, nutrient utilization efficiency, and nutrient loss among all test sites.

TABLE 2
Comparison between the one-off fertilization method and the traditional
fertilization method for winter wheat

| | | | | Utilization | |
|---|---|---|---|---|---|
| | | | Net | efficiency | Nitrate |
| | Wheat | Input cost | income | of nitrogen | nitrogen |
| | grain yield | (yuan · | (yuan · | fertilizer | loss (N |
| | (kg · ha⁻¹) | ha⁻¹) | ha⁻¹) | (%) | kg · ha⁻¹) |
| Traditional | 5865 | 7460 | 5443.0 | 29.2 | 9.90 |
| fertilization | | | | | |
| method | | | | | |
| One-off | 6172 | 7080 | 6498.4 | 34.3 | 7.65 |
| fertilization | | | | | |
| method | | | | | |

It could be seen from table 2 that compared with the traditional fertilization method, the one-off fertilization method for winter wheat increased the wheat gain yield by 5.23%. Moreover, in terms of cost saving and benefit increasing, the one-off fertilization method was obviously superior to the traditional fertilization with an average 1055.4 yuan increase in income per hectare, a 5.1% increase in nitrogen fertilizer utilization efficiency and a 22.7% reduction in nitrate nitrogen loss. Therefore, the one-off fertilization method had obvious technical advantages.

### Experimental Example 3

The one-off fertilization method suitable for winter wheat in areas with less rainfall in spring of embodiment 3 was used, and an experiment was conducted in 3 counties or cities including Tai'an, Longkou and Dezhou of Shandong Province from 2012 to 2013. For the traditional fertilization method, the input of each nutrient was the same as that in embodiment 3; the nitrogen, phosphorus and potassium were derived from compound fertilizers and urea fertilizers (the compound fertilizers were used as base fertilizers and were applied before seeding; land preparation was carried out by means of a deep ploughing in combination with a rotary tillage; in the erecting stage in spring, urea fertilizers were applied and then irrigation is conducted; and the ratio of basal fertilizer to top dressing of nitrogen fertilizers was 5:5), and after the fertilization and the land preparation, the seeding was carried out, wherein furrows were made by a seed-furrow opener and had a depth of 2 cm. Other field management and operations were consistent between the one-off fertilization and the traditional fertilization. Table 3 showed the comparative analysis for the seedling emergence, population composition, and average wheat grain yield among the three test sites.

TABLE 3
Comparison between the one-off fertilization method and the
traditional fertilization method for winter wheat

| | | Number of | Grain | | |
|---|---|---|---|---|---|
| | | spikes | number | Thousand | Wheat |
| | Emer- | (10,000 | per spike | grain | grain |
| | gence | spikes · | (grain/ | weight | yield |
| | rate (%) | ha⁻¹) | spike) | (g) | (kg · ha⁻¹) |
| Traditional | 92.3 | 577.5 | 34.1 | 38.8 | 6494.7 |
| fertilization | | | | | |
| method | | | | | |
| One-off | 95.8 | 593.5 | 34.3 | 39.0 | 6748.4 |
| fertilization | | | | | |
| method | | | | | |

It could be seen from table 3 that the one-off fertilization method for winter wheat had significant advantages over the traditional fertilization method in terms of emergence rate and the number of spikes. As for the grain number per spike and the thousand grain weight, although the top dressing of nitrogen was not applied in any later stage, they were comparable to those in the traditional fertilization method. Thus, the one-off fertilization method achieved a 253.7 kg·ha⁻¹ increase in final average yield, i.e., an increase rate of 3.9%, and had obvious effects.

### Experimental Example 4

The one-off fertilization method suitable for winter wheat in areas with less rainfall in spring of embodiment 4 was used, and an experiment was conducted in 5 typical counties or cities including Dingtao, Yuncheng, Tengzhou, Daiyue and Huantai of Shandong Province from 2013 to 2014 and from 2014 to 2015. For the traditional fertilization method, the input of each nutrient was the same as that in embodiment 4; the nitrogen, phosphorus and potassium were derived from compound fertilizers and urea fertilizers (the compound fertilizers were used as base fertilizers and were applied before seeding; land preparation was carried out by means of a deep ploughing in combination with a rotary tillage; in the early jointing stage in spring, urea fertilizers were applied and then irrigation was conducted; and the ratio of basal fertilizer to top dressing of nitrogen fertilizers was 5:5), and after the fertilization and the land preparation, the seeding was carried out, wherein furrows were made by a seed-furrow opener and had a depth of 3.5 cm. Other field management and operations were consistent between the one-off fertilization and the traditional fertilization. The average yield, cost-effectiveness, nutrient utilization efficiency, and nutrient loss were compared as follows.

TABLE 4
Comparison between the one-off fertilization method and the traditional
fertilization method for winter wheat

| | | | | Utilization | |
|---|---|---|---|---|---|
| | | | | efficiency | |
| | Wheat | | Net | of | Nitrate |
| | grain | | income | nitrogen | nitrogen |
| | yield | Input cost | (yuan · | fertilizer | loss (N |
| | (kg · ha⁻¹) | (yuan · ha⁻¹) | ha⁻¹) | (%) | kg · ha⁻¹) |
| Traditional | 8330 | 7540 | 10786 | 28.6 | 6.75 |
| fertilization | | | | | |
| method | | | | | |
| One-off | 8520 | 6840 | 11904 | 33.5 | 4.80 |
| fertilization | | | | | |
| method | | | | | |

It could be seen from table 4 that compared with the traditional fertilization method, the one-off fertilization method for winter wheat, although had no significant increase in wheat grain yield, in terms of input cost saving and benefit increasing, it was obviously superior to the traditional fertilization with an average 1118 yuan increase in income per hectare, a 4.9% increase in nitrogen fertilizer utilization efficiency and a 28.9% reduction in nitrate nitrogen loss, as well as a relatively small pollution threat to the groundwater. Therefore, the one-off fertilization method had obvious technical effects.

What is claimed is:

1. A one-off fertilization method for winter wheat in areas with less rainfall in spring, comprising the following steps:
(1) on a flat wheat block suitable for mechanized operations and after a harvest of preceding crops, carrying out a deep ploughing or a subsoiling in combination with a rotary tillage and a one-off fertilization for land preparation, without involving any top dressing in a later stage; and
(2) carrying out a seeding operation by a wheat seeder, wherein a fertilizer of the one-off fertilization comprises a nitrogen fertilizer, a phosphate fertilizer, and a potassium fertilizer,
for the nitrogen fertilizer, according to a nitrogen release period of a controlled-release nitrogen fertilizer, one of the following application modes is determined, and percentages are based on a total input of pure nitrogen:
a. applying a polyurethane-coated controlled-release nitrogen fertilizer alone;
b. applying a water-based resin-coated controlled-release nitrogen fertilizer special for wheat alone;
c. applying a water-based resin-coated controlled-release nitrogen fertilizer special for wheat in combination with 20% to 30% of a polyurethane-coated controlled-release nitrogen fertilizer; or
d. applying a thermoplastic or thermosetting resin-coated controlled-release nitrogen fertilizer in combination with 10% to 40% of a quick-acting nitrogen fertilizer;
the phosphate fertilizer is one selected from the group consisting of a monoammonium phosphate fertilizer, a diammonium phosphate fertilizer, a superphosphate fertilizer and a triple superphosphate fertilizer; and
the potassium fertilizer is a potassium chloride fertilizer or a potassium sulfate fertilizer; wherein
the nitrogen fertilizer, the phosphate fertilizer, and the potassium fertilizer are all in a form of granules; and
applied amounts of the nitrogen fertilizer, the phosphate fertilizer, and the potassium fertilizer are as follows:
for a wheat field with a high soil fertility, wherein a plough layer depth is equal to or more than 20 cm, a soil organic matter content for 0-20 cm of soil layer is equal to or more than 2.0%, a total nitrogen content is equal to or more than 0.125%, a alkali-hydrolyzable nitrogen content is equal to or more than 120 mg/kg, a quick-acting phosphorus content is equal to or more than 30 mg/kg, a quick-acting potassium content is equal to or more than 150 mg/kg and a pH is 6.0-8.0: applying 240-300 kg·ha⁻¹ of the nitrogen fertilizer (in pure N), 135-180 kg·ha⁻¹ of the phosphate fertilizer (in P₂O₅), and 105-150 kg·ha⁻¹ of the potassium fertilizer (in K₂O);
for a wheat field with a medium soil fertility, wherein, a plough layer depth is 15-20 cm, a soil organic matter content for 0-20 cm of soil layer is 1.5%-2.0%, a total nitrogen content is 0.10%-0.125%, a alkali-hydrolyzable nitrogen content is 90-120 mg/kg, a quick-acting phosphorus content is 20-30 mg/kg, a quick-acting potassium content is 100-150 mg/kg, and a pH is 8.0-8.5 or 5.5-6.0: applying 180-240 kg·ha⁻¹ of the nitrogen fertilizer (in pure N), 105-135 kg·ha⁻¹ of the phosphate fertilizer (in P₂O₅), and 75-105 kg·ha⁻¹ of the potassium fertilizer (in K₂O); and
for a wheat field with a low soil fertility, wherein a plough layer depth is equal to or less than 15 cm, a soil organic matter content for 0-20 cm of soil layer is equal to or less than 1.5%, a total nitrogen content is equal to or less than 0.10%, an alkali-hydrolyzable nitrogen content is equal to or less than 90 mg/kg, a quick-acting phosphorus content is equal to or less than 20 mg/kg, a quick-acting potassium content is equal to or less than 100 mg/kg, and a pH is 8.5-9.0 or 5.0-5.5: applying 120-180 kg·ha⁻¹ of the nitrogen fertilizer (in pure N), 75-105 kg ha⁻¹ of the phosphate fertilizer (in P₂O₅), and 45-75 kg·ha⁻¹ of the potassium fertilizer (in K₂O).

2. The one-off fertilization method for the winter wheat according to claim 1, wherein the polyurethane-coated controlled-release nitrogen fertilizer in the step (2) meets the following requirements: an initial release rate of nitrogen is equal to or less than 12%, a cumulative nutrient release rate within 28 days is equal to or less than 75%, a cumulative nutrient release rate in the nitrogen release period is equal to or more than 80%, and a release period of nitrogen nutrients is equal to or more than 60 days.

3. The one-off fertilization method for winter wheat according to claim 1, wherein the water-based resin-coated controlled-release nitrogen fertilizer special for the winter wheat in the step (2) meets the following requirements: an initial release rate of nitrogen is equal to or less than 12%, a cumulative nutrient release rate within 28 days is equal to or less than 75%, and a cumulative nutrient release rate in the nitrogen release period is equal to or more than 80%; and if the nitrogen release period is equal to or more than 60 days, the fertilizer special for the winter wheat is applied alone; and if the nitrogen release period is more than 28 days, the fertilizer special for the winter wheat is applied in combination with 20% to 30% of the polyurethane-coated controlled-release nitrogen fertilizer.

4. The one-off fertilization method for the winter wheat according to claim 1, wherein the thermoplastic or thermosetting resin-coated controlled-release nitrogen fertilizer in the step (2) meets the following requirements: an initial release rate of nitrogen is equal to or less than 12%, a cumulative nutrient release rate within 28 days is equal to or less than 75%, and a cumulative nutrient release rate in a nitrogen release period is equal to or more than 80%; and if the nitrogen release period of the fertilizer of a product is more than 120 days, the product is applied in combination with 30% to 40% of a quick-acting nitrogen fertilizer; and if the nitrogen release period of the fertilizer of the product is equal to or less than 120 days, the product is applied in combination with 10% to 30% of a quick-acting nitrogen fertilizer.

5. The one-off fertilization method for the winter wheat according to claim 1, wherein the quick-acting nitrogen fertilizer is a common urea fertilizer with a nitrogen content equal to or more than 46%, a monoammonium phosphate fertilizer with a nitrogen content equal to or more than 12%, or a diammonium phosphate fertilizer with a nitrogen content equal to or more than 18%.

6. The one-off fertilization method for the winter wheat according to claim 1, wherein the method for the seeding operation is as follows: the wheat seeder in the step (2) is hung on a tractor and is operated with a traction of the tractor; furrows are made by a furrow opener, wherein the furrow opener is connected to a seed tank of the wheat seeder; seeds fall into the furrows having a depth of 2 cm to 4 cm, and a pressing operation is performed by press wheels immediately after seed falling.
